(19) United States
(12) Patent Application Publication
(10) Pub. No.: US 2016/0308243 A1
(43) Pub. Date: Oct. 20, 2016

(54) ELECTROCHEMICAL CELL WITH SOLID AND LIQUID ELECTROLYTES

(71) Applicant: Applied Materials, Inc., Santa CLara, CA (US)

(72) Inventors: Subramanya P. HERLE, Mountain View, CA (US); Joseph G. GORDON, San Jose, CA (US)

(73) Assignee: APPLIED MATERIALS, INC., Santa Clara, CA (US)

(21) Appl. No.: 14/781,281

(22) PCT Filed: Apr. 22, 2014
(86) PCT No.: PCT/US2014/035011

§ 371 Date: Sep. 29, 2015

Related U.S. Application Data
(60) Provisional application No. 61/815,102, filed on Apr. 23, 2013.

(51) Int. Cl. H01M 10/0525; H01M 4/38; H01M 10/0562; H01M 4/131; H01M 4/505; H01M 4/62; H01M 4/66; H01M 10/0585; H01M 4/40; H01M 4/36; H01M 4/1395; H01M 4/1391; H01M 4/04; H01M 4/525; H01M 10/0564; H01M 4/134

(52) U.S. Cl. CPC H01M 10/0525; H01M 4/134; H01M 4/382; H01M 10/0562; H01M 4/131; H01M 4/505; H01M 4/623; H01M 4/661; H01M 10/0585; H01M 4/405; H01M 4/366; H01M 4/1395; H01M 4/1391; H01M 4/0404; H01M 4/625; H01M 4/525; H01M 10/0564; H01M 2004/027

(57) ABSTRACT

A hybrid solid state battery may comprise: a metal ion negative half-cell; a metal ion conducting solid state electrolyte separator; and a positive half-cell comprising an electrolyte selected from the group consisting of a liquid electrolyte, a gel electrolyte and a polymer electrolyte; wherein the solid state electrolyte separator is between the metal ion negative half-cell and the electrolyte in the positive half-cell. The solid state battery may be a Li-ion battery, with a Li-ion conducting solid state electrolyte separator, such as one or more of LiPON, Li₇La₃Zr₂O₁₂, doped anti-perovskite compositions, Li₂S—P₂S₅, Li₁₀GeP₂S₁₂, and Li₃PS₄, for example. A method of fabricating a Li-ion cell may comprise combining a lithium metal electrode, a solid state electrolyte separator and a positive half-cell, wherein the positive half-cell comprises a liquid/get/polymer electrolyte and wherein the solid state electrolyte is between the lithium metal electrode and the liquid/gel/polymer electrolyte in the positive half-cell.

### CROSS-REFERENCE TO RELATED APPLICATIONS

This application claims the benefit of U.S. Provisional Application Ser. No. 61/815,102 filed Apr. 23, 2013.

### FIELD

Embodiments of the present disclosure relate generally to energy storage devices such as Li-ion batteries and in embodiments more specifically to electrochemical cells with a solid electrolyte half-cell and a liquid electrolyte half-cell.

### BACKGROUND

The current generation of Li-ion batteries consists of a positive electrode and a negative electrode separated by a porous separator and a liquid electrolyte used as the ionic conductive matrix. Typically, the negative electrode is graphite or hard carbon, although higher energy density could be achieved if the negative electrode were Li metal or Li-alloy. Lithium metal and its alloys are not used for the negative electrode in conventional cells because after repeated use (multiple cycles of charging and discharging) the lithium metal electrode develops a very high surface area and can grow dendrites that make the electrode very reactive with the liquid electrolyte. Furthermore, these dendrites can cause shorts within the battery cell. Shorting of the negative electrode to the positive electrode and overheating of the cell may even cause a fire. Shorts may be caused by one or more of: (a) conductive asperities or particles in the cell which are introduced during manufacturing; (b) dendrites that grow from one electrode to the other during operation of the cell (dendritic growth of Li metal on the negative electrode is often observed in liquid electrolytes.); and (c) shrinking of the separator due to overheating. To prevent shorts, cells are currently designed with thick, strong separators which may also incorporate advanced structures—for example, separators impregnated or coated with ceramic nano-particles to prevent shorting after heating. Also, reactions between the electrolytes and the other active materials in the cell can result in nominally identical cells having different rates of capacity aging. This makes series stacking difficult as the imbalance reduces the available capacity of the series stack and can result in safety issues—for example, over charging of some cells in the battery due to stacking of cells with different capacities may cause premature failure or thermal runaway of overcharged cells. These potential problems are addressed in today's batteries as follows: (1) by incorporating safety elements in the cells—pressure release vents and switches, and PTC (positive temperature coefficient) current limiters; (2) monitoring the battery pack by the battery pack electronics—e.g. monitoring temperature, voltage of each cell or parallel set, total stack voltage and total pack current; and (3) by using protective battery enclosures and, sometimes, active cooling. All of these measures add expense and reduce the energy density at the cell and pack level.

There is a need for high-energy density Li-ion batteries with nonflammable solid state electrolytes that can avoid the aforementioned problems associated with today's liquid electrolyte cells.

### SUMMARY

The transition to a fully solid electrolyte Li-ion battery is not without major technical and manufacturing challenges. Therefore, in order to facilitate the transition to solid state electrolyte-based Li-ion batteries, a manufacturing transition is proposed wherein both liquid/polymer/gel electrolyte and solid state electrolyte are used together in a Li-ion cell, and an increasing proportion of solid state electrolyte replacing conventional electrolytes is envisaged. For example, one way to overcome the safety problems associated with a liquid electrolyte battery cell, and yet still reap the increased energy density benefit of lithium metal or alloy, is to place a solid state electrolyte in contact with the lithium metal or alloy negative electrode and between the lithium metal or alloy negative electrode and the rest of the cell containing a liquid electrolyte. The solid state electrolyte inhibits the formation of dendrites that penetrate the separator and acts as a barrier—preventing contact of the lithium with the liquid electrolyte. The positive half-cell can be constructed using a conventional positive electrode infused with a liquid, gel or polymer electrolyte. Using a Li-ion conducting ceramic material as a membrane between the negative electrode and a solid, liquid, gel or polymer electrolyte filled positive electrode also helps to improve the safety of the cell.

According to some embodiments, a hybrid solid state battery may comprise: a metal ion negative half-cell; a metal ion conducting solid state electrolyte separator; and a positive half-cell comprising an electrolyte selected from the group consisting of a liquid electrolyte, a gel electrolyte and a polymer electrolyte; wherein the metal ion conducting solid state electrolyte separator is between the metal ion negative half-cell and the electrolyte in the positive half-cell. The solid state battery may be a Li-ion battery, with a Li-ion conducting solid state electrolyte separator. The Li-ion conducting solid state electrolyte separator may be comprised of one or more of LiPON, doped variants of either crystalline or amorphous phases of Li₇La₃Zr₂O₁₂, doped anti-perovskite compositions, Li₂S—P₂S₅, Li₁₀GeP₂S₁₂, and Li₃PS₄, for example. The liquid/gel/polymer electrolyte may be in contact with the Li-ion conducting solid state electrolyte separator. The Li-ion conducting solid state electrolyte separator can be directly deposited on the negative electrode using a PVD, CVD, printing/coating or spray method. A barrier layer may be necessary in between the negative electrode and Li-ion conducting solid state electrolyte separator to prevent side reactions of materials with the negative electrode, or to enhance the surface contact between the interfaces. This barrier layer may or may not absorb Li, but will facilitate a “smooth” transfer of Li-ions across the interface. The positive electrode may be a porous electrode which can be fabricated using processes such as slurry coating, plasma/thermal spray coating, printing etc. The pores within the positive electrode can be filed with liquid/polymer/gel electrolytes—that is an electrolyte in the form of at least one of a liquid, a polymer and a gel.

According to some embodiments, a method of fabricating a Li-ion cell may comprise combining a lithium metal electrode, a solid state electrolyte separator and a positive half-cell, wherein the positive half-cell comprises a liquid/gel/polymer electrolyte and wherein the solid state electrolyte is between the lithium metal electrode and the liquid/gel/polymer electrolyte in the positive half-cell.

### BRIEF DESCRIPTION OF THE DRAWINGS

These and other aspects and features of the present disclosure will become apparent to those ordinarily skilled in the art upon review of the following description of specific embodiments in conjunction with the accompanying figures, wherein:

FIG. 1 is a cross-sectional representation of a hybrid battery cell, according to some embodiments; and

FIGS. 2-4 are process flows for forming a hybrid battery cell, according to some embodiments.

### DETAILED DESCRIPTION

Embodiments of the present disclosure will now be described in detail with reference to the drawings, which are provided as illustrative examples of the disclosure so as to enable those skilled in the art to practice the disclosure. The drawings provided herein include representations of devices and device process flows which are not drawn to scale. Notably, the figures and examples below are not meant to limit the scope of the present disclosure to a single embodiment, but other embodiments are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure. In the present specification, an embodiment showing a singular component should not be considered limiting; rather, the disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

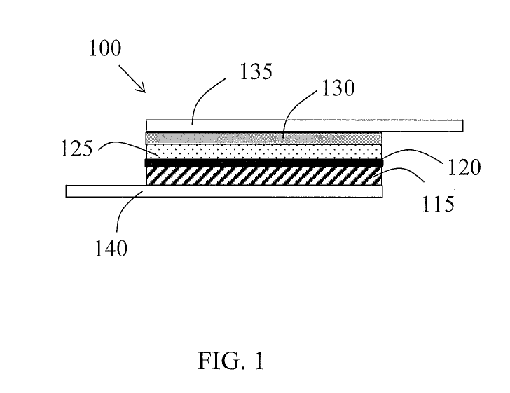

FIGS. 1-4 show hybrid solid/liquid battery structures and methods according to some embodiments. A cross-sectional representation of an example of a hybrid solid state electrolyte and liquid electrolyte cell 100 is shown in FIG. 1, with a positive current collector 135, a positive electrode with active material (with or without binder and carbon black), and liquid/polymer/gel/solid electrolyte 130, a solid state electrolyte separator 125 such as a ceramic Li-ion conducting film, a negative electrode 115 and a negative current collector 140. Note in FIG. 1 that the current collectors are shown to extend beyond the stack, although it is not necessary for the current collectors to extend beyond the stack. The portions extending beyond the stack may be used as tabs for making electrical connection to the cell.

In some embodiments a Li-ion battery may consist of a Li metal or alloy negative electrode facing a solid state electrolyte separator (e.g. UPON, Li₇La₃Zr₂O₁₂, etc.) and a positive electrode (for example Li(Co,Ni,Mn)O₂ infused with a liquid or gel or polymer electrolyte or combinations thereof with a dispersed solid state electrolyte to provide ion transport and to improve the interfacial resistance between the solid state electrolyte separator and the positive electrode active material).

The lithium ion conducting solid state electrolyte separator may be formed of materials such as LiPON, garnet based Li₇La₃Zr₂0₁₂ (LLZO), doped anti-perovskite compositions, Li₁₀GeP₂S₁₂, and/or high surface area beta-Li₃PS₄ (Li—S type) based compositions. These compositions can be amorphous or crystalline in nature and may contain other elements as dopants or impurities. The solid state electrolyte separator may be a multilayer structure, where the materials are chosen for properties such as chemical stability when in contact with lithium and the liquid/polymer/gel electrolyte, and where certain layers of a multilayer structure can be used to protect underlying moisture sensitive layers such as anti-perovskites and sulfides. Furthermore, the solid state electrolyte separator may in embodiments be a composite structure—for example moisture sensitive solid state electrolyte material may be combined with a protective material.

Furthermore, the interface between a metallic lithium negative electrode and a solid state electrolyte may include a layer of silicon, copper nitride, sodium-substituted lithium phosphate or borate, or Li₃₋ₓPO_{4-y}N_{y} to avoid reduction of metals in the solid electrolyte at lower potentials than desired.

The Li metal negative electrode may be deposited with a Li absorbing thin layer 120 (<100 nm thick) of compounds such as Si, Sn, SiOₓ, etc. at the interface with the solid state electrolyte, which alloy with lithium to provide a good physical interface with low electrical impedance.

Various configurations of positive electrode may be used in the different embodiments. For example, the positive electrode may be: a conventional positive electrode active coating with a liquid/gel/polymer electrolyte at the interface with the separator. The active material can be blended with or without a conductive additive, a polymer binder, a dispersed lithium-ion conducting solid state electrolyte, and a lithium ion conducting liquid/gel/polymer. The positive electrode may be deposited by conventional slurry coating, screen printing or plasma spray coating. Furthermore, the positive electrode may be deposited with or without a liquid, gel or polymer electrolyte and the active material may be blended with a Li-conducting solid electrolyte to reduce the organic electrolyte content of the electrode. Furthermore, in embodiments the dispersed lithium ion conducting solid state electrolyte may also be an electrical conductor.

The positive electrode may contain additives such as carbon nano-tubes, VGCF (vapor grown carbon nano-fiber), carbon black, etc., a mixed ionic and electronic conductor such as Li doped LaTiO₃, and a pure ionic conductive additive such as Li₇₋ₓLa₃Zr₂₋ₓTaₓO₁₂ where x=0 to 1. For low temperature compaction, soft lithium conducting materials such as sulfides and doped anti-perovskites can be used along with appropriate moisture protective particle coatings.

The current collectors 140, 135, on negative and positive electrodes, respectively, can be identical or different electronic conductors. Negative current collector 140 can be a metal that does not alloy with Li at the charging voltage. In embodiments the positive current collector 135 is a metal that is compatible with the positive electrode active material. Typically the negative current collector is copper and the positive current collector is aluminum. The current collectors can be deposited on carrier substrates or can be pre-existing conductive foils or plates example materials for current collectors are copper, aluminum, carbon, nickel, metal alloys, etc. Furthermore, current collectors may be of any form factor, shape and micro/macro structure. Generally, in prismatic cells, tabs are formed of the same material as the current collector and may be formed during fabrication of the stack, or added later.

Depending on the specific combination of materials, the average voltage of a fully charged cell may be engineered by suitable choice of negative half-cell lithium alloying materials and positive half-cell active materials.

FIG. 1 shows a schematic representation of a cell. Methods for fabrication of the cell include a continuous process, such as a roll-to-roll process, and a serial process for sheets or disks. A negative current collector 140 and negative (Li) electrode 115 are provided. A thin or thick Li-absorbing layer 120 may be deposited on the surface of the Li electrode. A solid state electrolyte 125 is deposited on the surface of layer 120 either by Physical Vapor Deposition (PVD), Chemical Vapor Deposition (CVD), spray, doctor blade or printing or any of a number of coating methods. A suitable method for some embodiments is PVD. Alternatively, 120 and 115 may be sequentially deposited on a preformed solid electrolyte separator 125. A positive electrode 130 is deposited on the surface of a current collector 135. The deposition process for the positive electrode may be slurry coating, printing, plasma spray, PVD, CVD, etc., for example. Note that a dry air or inert gas environment will be needed for fabrication of the Li metal electrode and any subsequent processing until the electrode is fully encapsulated. The positive electrode 130 and current collector 135 are laminated on top of the separator 125. When a continuous roll-to-roll process is used the stack may be cut to form individual cells—mechanical cutting, scribe and fracture, laser cutting, etc., processes might be used, providing the processes do not smear cell edges and/or cause shorting of electrodes. Attaching tabs, addition of liquid electrolyte to the positive electrode and sealing or encapsulation complete the fabrication process. The liquid, polymer or gel electrolyte can be infused into the pores of the positive electrode under vacuum with or without thermal treatment.

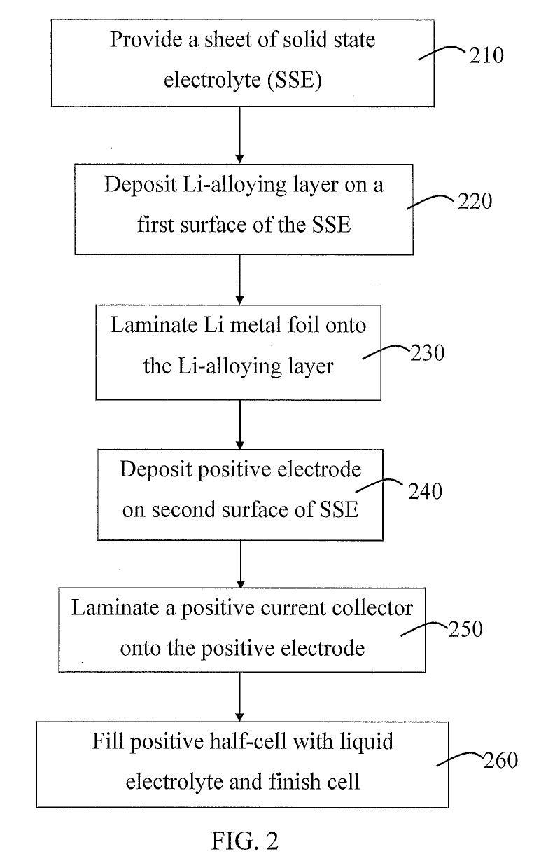

According to other embodiments, variations in the fabrication method may include process flows starting with the solid state electrolyte—examples of such a fabrication method are shown in the process flows of FIGS. 2 & 3.

In FIG. 2 a sheet of solid state electrolyte (SSE) is provided (210). A layer of Li-alloying material is deposited on a first surface of the SSE sheet (220). Li metal is deposited on the layer of Li-alloying material and the stack may be laminated to ensure a good mechanical and electrical interface between the Li electrode and the SSE (230). A positive electrode is deposited on the second surface of the SSE (240). A positive current collector is laminated onto the positive electrode (250). The positive half-cell is filled with a liquid electrolyte and the cell is finished (260). Note that the SSE may need a carrier substrate to provide mechanical integrity during the initial processing, in which case the SSE with negative electrode will need to be separated from the carrier substrate before the positive electrode is deposited on the second surface of the SSE.

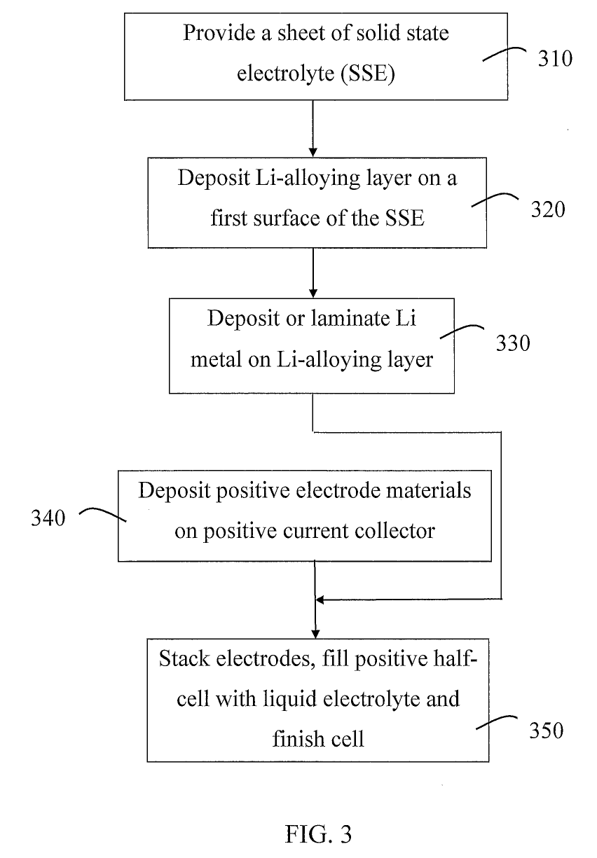

In another approach as shown in FIG. 3, the positive and negative electrodes are fabricated independently and subsequently stacked. The negative electrode is fabricated by providing a sheet of solid state electrolyte (SSE) (310); depositing a layer of Li-alloying material on a first surface of the SSE sheet (320); and depositing Li metal on the layer of Li-alloying material and the stack may be laminated to ensure a good mechanical and electrical interface between the Li electrode and the SSE (330). The positive electrode is fabricated by coating/depositing the positive electrode materials onto the positive current collector (340). The coated electrodes are stacked and the positive half-cell is filled with electrolyte to make a cell (350). For example, according to some embodiments, a method of fabricating a Li-ion cell may comprise: laminating a lithium metal foil to a preformed Li ion conducting solid state electrolyte plate; slurry coating a metal current collector (typically aluminum foil) with a composite of a lithium metal oxide (LMO), a conductive additive (carbon black) and a polymeric binder; stacking the lithium/solid state electrolyte preform onto the LMO coated metal foil; filling the LMO coated metal foil half-cell with liquid electrolyte; and encapsulating the Li-ion cell.

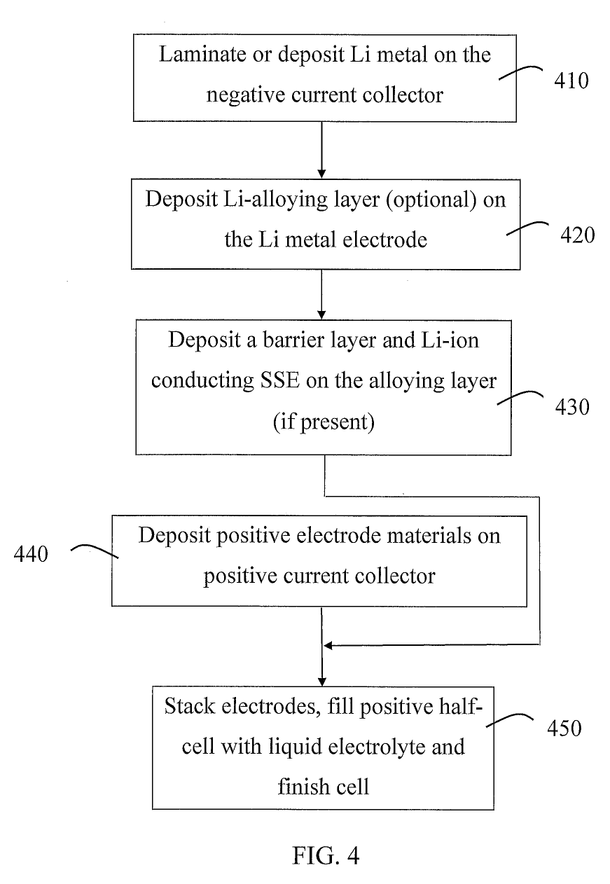

A third approach, such as shown in FIG. 4, is to fabricate the negative electrode by coating/depositing (e.g., PVD) or laminating lithium metal to the negative current collector (410), optionally depositing a Li-alloying layer on the lithium metal electrode (420), and then applying/depositing the barrier layer and SSE to the lithium metal or Li-alloying layer (430); the positive electrode is fabricated by coating active positive electrode materials onto the positive current collector (440) and then the cell is assembled by stacking the subcomposite electrodes and filling the positive half-cell with liquid/gel/polymer electrolyte and finishing the cell (450). For example, according to some embodiments, a method of fabricating a Li-ion cell may comprise: coating a lithium metal foil with Li-ion conducting solid state electrolyte; coating a metal current collector (typically aluminum foil) with a composite of a lithium metal oxide (LMO), a conductive additive (e.g. carbon black) and a polymeric binder (e.g. PVDF); stacking the lithium/solid state electrolyte preform onto the LMO coated metal foil; filling the LMO coated portion of the cell with liquid electrolyte; and encapsulating the Li-ion cell. For example, according to further embodiments, a method of fabricating a Li-ion cell may comprise: coating a copper or other lithium compatible metal foil with a Li-ion conducting solid state electrolyte; coating a metal current collector (typically aluminum foil) with a composite of a lithium metal oxide (LMO), a conductive additive (carbon black) and a polymeric binder; stacking the metal foil/solid state electrolyte preform onto the LMO coated metal foil; filling the LMO coated portion of the cell with liquid electrolyte; and encapsulating the Li-ion cell. Before coating the copper metal foil with solid electrolyte, a thin wetting layer or a thick reservoir layer of a lithium alloying material (such as Si, Al and/or Mg) may be applied.

The electrochemical cells of the present disclosure may typically range in thickness between 10 and 500 microns, where, for example, the positive and negative electrodes are each 10 to 150 microns thick, the separator is 3 to 25 microns thick, and the current collector(s) are each 1 to 50 microns thick.

The electrochemical cell when assembled has just a solid state electrolyte on the negative electrode side and a liquid, gel, or polymer electrolyte on the positive side. The liquid electrolyte content of the battery is less than that of a conventional liquid electrolyte Li-ion cell, and the liquid/gel/polymer electrolyte does not come in contact with metallic lithium which results in improved battery safety; furthermore, the use of lithium metal or lithium alloy results in higher energy density and higher specific energy than a conventional Li-ion battery. The batteries of the present disclosure are expected to be suitable for use in portable electronics, power tools, medical devices, sensors, and may also be used in other energy storage applications.

Although the present disclosure has been described with reference to Li-ion batteries, other hybrid solid state batteries may also be fabricated using the teaching and principles of the present disclosure. For example, the teaching and principles of the present disclosure may be applied to Na-ion batteries.

Although embodiments of the present disclosure have been particularly described with reference to certain embodiments thereof, it should be readily apparent to those of ordinary skill in the art that changes and modifications in the form and details may be made without departing from the spirit and scope of the disclosure.

What is claimed is:

1. A hybrid solid state battery comprising:
a metal ion negative half-cell;
a metal ion conducting solid state electrolyte separator; and
a positive half-cell comprising an electrolyte selected from the group consisting of a liquid electrolyte, a gel electrolyte and a polymer electrolyte;
wherein said metal ion conducting solid state electrolyte separator is between said metal ion negative half-cell and said electrolyte in said positive half-cell.

2. The hybrid solid state battery of claim 1, wherein said solid state battery is a Li-ion battery.

3. The hybrid solid state battery of claim 1, wherein said positive half-cell further comprises a dispersed solid state electrolyte.

4. The hybrid solid state battery of claim 1, wherein said electrolyte in said positive half-cell is a liquid electrolyte.

5. The hybrid solid state battery of claim 1, wherein said metal ion conducting solid state electrolyte separator is a multilayer structure.

6. A Li-ion battery comprising:
a lithium metal electrode;
a lithium ion conducting solid state electrolyte separator; and
a positive half-cell comprising an electrolyte selected from the group consisting of a liquid electrolyte, a gel electrolyte and a polymer electrolyte;
wherein said Li-ion conducting solid state electrolyte separator is between said lithium metal electrode and said electrolyte in said positive half-cell.

7. The Li-ion battery of claim 6, wherein said Li-ion conducting solid state electrolyte separator comprises LiPON.

8. The Li-ion battery of claim 6, wherein said Li-ion conducting solid state electrolyte separator comprises high surface area beta-Li₃PS₄.

9. The Li-ion battery of claim 6, wherein said positive half-cell further comprises a metal current collector coated with a composite of a lithium metal oxide, a conductive additive and a polymeric binder.

10. A method of fabricating a Li-ion cell comprising:
combining a lithium metal electrode, a Li-ion conducting solid state electrolyte separator and a positive half-cell,
wherein said positive half-cell comprises an electrolyte selected from the group consisting of a liquid electrolyte, a gel electrolyte and a polymer electrolyte and
wherein said Li-ion conducting solid state electrolyte separator is between said lithium metal electrode and said electrolyte in said positive half-cell.

11. The method of claim 10, wherein said combining comprises:
providing a sheet of Li-ion conducting solid state electrolyte;
depositing a lithium-alloying layer on a first surface of said sheet of Li-ion conducting solid state electrolyte;
laminating lithium metal foil onto said lithium-alloying layer;
depositing a positive electrode on a second surface of said sheet of Li-ion conducting solid state electrolyte;
laminating a positive current collector onto said positive electrode; and
filling said positive half-cell with liquid electrolyte.

12. The method of claim 11, wherein said depositing said positive electrode is by a physical vapor deposition process.

13. The method of claim 10, wherein said combining comprises:
providing a sheet of Li-ion conducting solid state electrolyte;
depositing a lithium-alloying layer on a first surface of said sheet of Li-ion conducting solid state electrolyte;
depositing or laminating lithium metal foil onto said lithium-alloying layer;
depositing a positive electrode on a positive current collector;
stacking electrodes wherein said positive electrode is in contact with a second surface of said Li-ion conducting solid state electrolyte; and
filling said positive half-cell with liquid electrolyte.

14. The method of claim 10, wherein said combining comprises:
laminating or depositing lithium metal on a negative current collector;
depositing a lithium-alloying layer on said lithium metal electrode;
depositing a barrier layer and Li-ion conducting solid electrolyte on said alloying layer;
depositing a positive electrode on a positive current collector;
stacking electrodes wherein said positive electrode is in contact with a surface of said Li-ion conducting solid state electrolyte; and
filling said positive half-cell with liquid electrolyte.

15. The method of claim 10, wherein said depositing said Li-ion conducting solid state electrolyte is by a physical vapor deposition process.
